(19) United States
(12) Patent Application Publication
(10) Pub. No.: US 2006/0294236 A1
(43) Pub. Date: Dec. 28, 2006

(54) System, device, and method of selectively operating a host connected to a token

(76) Inventor: Hagai Bar-El, Rehovot (IL)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 11/455,845

(22) Filed: Jun. 20, 2006

Related U.S. Application Data
(60) Provisional application No. 60/692,576, filed on Jun. 22, 2005.

(51) Int. Cl. G06F 15/173

(52) U.S. Cl. 709/225

(57) ABSTRACT

Some demonstrative embodiments of the invention include a method, device and/or system to selectively operate a host connected to a token. The device may include, for example, a host processor to communicate with the token; and a secure module including a secure unit; and a controller to authenticate an identity of the token and, based on the identity, to selectively allow the secure unit to interact with another unit of the host. Other embodiments are described and claimed.

### CROSS REFERENCE TO RELATED APPLICATIONS

This application claims priority of U.S. Provisional Application No. 60/692,576, filed Jun. 22, 2005, the entire disclosure of which is incorporated herein by reference.

### BACKGROUND OF THE INVENTION

A conventional cellular device, e.g., a cellular handset, may be connected to a token, e.g., a Subscriber Identity Module (SIM). Each SIM may have an identity, which may be defined, for example, by a sequence of numbers and/or symbols.

Some conventional protection mechanisms may include performing a trusted Boot process able to verify the cellular device is connected to a predefined SIM. However, in order to implement the trusted Boot process it may be required to perform hardware modifications to a host processor of the cellular device.

### SUMMARY OF SOME DEMONSTRATIVE EMBODIMENTS OF THE INVENTION

Some demonstrative embodiments of the invention include a method, device and/or system to selectively operate a host connected to a token.

According to some demonstrative embodiments of the invention, the device may include, for example, a host processor to communicate with the token; and a secure module including a secure unit; and a controller to authenticate an identity of the token and, based on the identity, to selectively allow the secure unit to interact with another unit of the host.

According to some demonstrative embodiments of the invention, the secure unit may include a memory, and/or the controller may selectively allow access to one or more memory addresses of the memory based on the identity.

According to some demonstrative embodiments of the invention, the secure module may maintain access information indicating at least one allowed token to allow access to one or more selectively-allowed addresses of the memory. The controller may selectively allow access to the selectively-allowed addresses based on the access information.

According to some demonstrative embodiments of the invention, the secure module may include an indicator having an allow state and a block state. The controller may allow access to the selectively-allowed addresses, e.g., only when the indicator is at the allow state. The controller may selectively set the indicator to the allow state, e.g., based the identity of the token. The indicator may be set to the block state, e.g., when the secure module is booted. The controller may allow access to one or more other memory addresses of the memory, e.g., when the indicator is at the block state. For example, the controller may allow performing only a read operation on the other memory addresses, e.g., when the validity indicator is at the block state.

According to some demonstrative embodiments of the invention, the at least one allowed token may include at least one group of two or more allowed tokens. The controller may allow access to the selectively-allowed addresses, for example, if the identity of the token matches one of the two or more allowed tokens.

According to some demonstrative embodiments of the invention, the controller may authenticate an update request to update the access information.

According to some demonstrative embodiments of the invention, the memory may include a non-volatile memory, e.g., an embedded flash memory.

According to some demonstrative embodiments of the invention, the controller may perform a challenge-response authentication process to authenticate the identity of the token.

According to some demonstrative embodiments of the invention, the device may include a wireless communication device.

According to some demonstrative embodiments of the invention, the device may include a cellular handset.

According to some demonstrative embodiments of the invention, the token may include, for example, a subscriber-identity-module, a universal subscriber identity module, or a removable user identity module.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a system including a host connectable to a token according to some demonstrative embodiments of the invention; and

FIG. 2 is a schematic flowchart of a method of operating a host connected to a token according to some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art. An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Embodiments of the present invention may include apparatuses for performing the operations herein. These apparatuses may be specially constructed for the desired purposes, or they may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, a Dynamic RAM DRAM), a Synchronous DRAM (SD-RAM), a Flash memory, a volatile memory, a non-volatile memory, a cache memory, a buffer, a short term memory unit, a long term memory unit, or any other type of media suitable for storing electronic instructions, and capable of being coupled to a computer system bus.

Part of the discussion herein may relate, for demonstrative purposes, to accessing a memory address (“address”). However, embodiments of the invention are not limited in this regard, and may include, for example, accessing a range of memory addresses, a group of memory addresses, a set of memory addresses, a subset of memory addresses, a portion of a memory, a memory location, a memory field, or the like.

Some demonstrative embodiments of the invention may include a method, device and/or system to operate a host connectable to a token. The host may include, for example, a host processor to communicate with the token; and a secure module, which may include, for example, a secure unit, e.g., a memory; and a controller able to authenticate an identity of the token, e.g., via the host processor, and selectively allow the secure unit to interact with at least one other unit of the host, e.g., not included within the secure module. For example, the secure unit may include a memory, and the controller may selectively allow the host processor to access one or more memory addresses of the memory based on the identity of the token, e.g., as described in detail below. Although the invention is not limited in this respect, the term “token” as used herein may refer to a security token, an authentication token, a Universal Serial Bus (USB) security token, a hardware token, a smartcard, a Subscriber Identity Module (SIM), a Universal SIM (USIM), and/or a Removable User Identity Module (RUIM), e.g., as are all well known in the art.

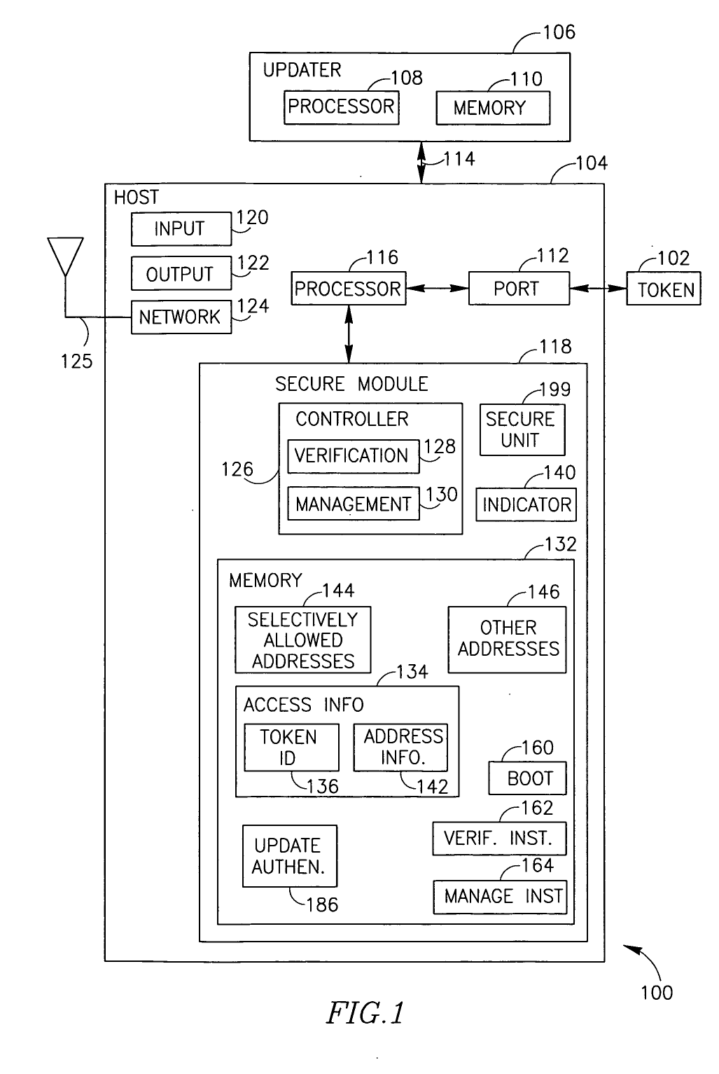

Reference is made to FIG. 1, which schematically illustrates a system 100 according to some demonstrative embodiments of the invention.

According to some demonstrative embodiments of the invention, system 100 may include a host 104 connectable to a token 102, as are both described in detail below.

Although the present invention is not limited in this respect, host 104 may include or may be a portable device. Non-limiting examples of such portable devices include mobile telephones, cellular handsets, laptop and notebook computers, personal digital assistants (PDA), and the like. For example, host 104 may include or may be a laptop, and/or token 102 may include a USB security token. Alternatively, host 104 may be a non-portable device.

According to some demonstrative embodiments of the invention, host 104 may include a port 112 adapted to connect to token 102. Port 112 may include any suitable token port, terminal and/or reader, as are well known in the art. For example, port 122 may enable transferring data between token 102 and host 104, provide token 102 with electrical power, and/or provide token 102 with a clock signal, e.g., as known in the art.

According to some demonstrative embodiments of the invention, host 104 may also include a host processor 116, a secure module 118, an input 120, an output 122, and/or a network connection 124, e.g., as are all described in detail below.

According to some demonstrative embodiments of the invention, host processor 116 may include a Central Processing Unit (CPU), a Digital Signal Processor (DSP), a microprocessor, a plurality of processors, a controller, a chip, a microchip, or any other suitable multi-purpose or specific processor or controller. Input 120 may include, for example, a keyboard, a mouse, a touch-pad, or other suitable pointing device or input device. Output 122 may include, for example, a Liquid Crystal Display (LCD), or any other suitable monitor or display. Network connection 124 may be adapted to interact with a communication network. Although the scope of the present invention is not limited in this respect, the communication network may include a cellular communication network, with host 104 being, for example, a cellular handset. The cellular communication network, according to some embodiments of the invention, may be a 3^{rd} Generation Partnership Project (3GPP), such as, for example, Frequency Domain Duplexing (FDD), Global System for Mobile communications (GSM), Wideband Code Division Multiple Access (WCDMA) cellular communication network and the like. Although the invention is not limited in this respect, network connection 124 may include, for example, at least one antenna 125 to transmit and/or receive signals to/from the communication network.

According to demonstrative embodiments of the invention, secure module 118 may include any suitable protection mechanism, e.g., any suitable “physical” protection structure and/or any other suitable protection configuration as is known in the art, to prevent unauthorized disclosure of the contents of module 118; to prevent an attempt to access any part of the contents of module 118; to prevent an attempt to tamper or alter the contents of module 118, in part or in whole; and/or to prevent an attempt to interfere with the operation of module 118. It will be appreciated that the term “preventing unauthorized disclosure of stored data” as used herein may refer to ensuring the stored data may not be understood without authorization, for example, even if access, e.g., partial or complete physical and/or electronic access, to the stored data is obtained. It will also be appreciated that the term “securely maintaining data” as used herein may refer to maintaining data, while preventing unauthorized disclosure of the maintained data

According to some demonstrative embodiments of the invention, secure module 118 may include a memory 132, and a controller 126 able to selectively allow a secure unit of module 118, e.g., memory 132 and/or a secure unit 199, to interact with one or more units of host 104, e.g., external to secure module 118, as described in detail below. For example, controller 126 may selectively allow processor 116 access to memory 132, e.g., as described in detail below.

According to some demonstrative embodiments of the invention, controller 126 may authenticate an identity of token 102, e.g., via host processor 116, and selectively allow processor 116 access to one or more addresses of memory 132, for example, based on the identity of token 102, e.g., as described in detail below. Controller 126 may block access to one or more addresses of memory 132, for example, if the identity of token 102 does not match one or more predefined allowed token identities, and/or if the identity of token 102 is not obtained or authenticated by controller 126. Although the invention is not limited in this respect, controller 126 may also selectively allow one or more operations, e.g., read and/or write operations, to be performed on one or more addressed of memory 132 based, for example, on the identity of token 102, e.g., as described below. The one or more addresses may include one or more addresses including data, instructions, code, and/or information, which may be required for the functionality and/or operation, in part or in whole, of host 104. Accordingly, controller 126 may selectively disable, partially or entirely, processor 116 from performing one or more operations using memory 132, e.g., based on the identity of token 102.

Although the present invention is not limited in this respect, secure module 118 may be integrally connected to, or included within host 104. For example, host 104 may include, or may be, a mobile telephone or a cellular handset; and module 118 may include or may be, for example, a memory, e.g., a Flash memory, connected to or embedded within the mobile telephone or handset. Although the invention is not limited in this respect, according to these demonstrative embodiments of the invention, token 102 may include a SIM connectable to the cellular handset. Controller 126 may selectively disable the operation or the functionality of the telephone or handset, partially or entirely, and/or prevent the use of the telephone or handset. For example, controller 126 may selectively block access of host processor 116 to one or more addresses of memory 132, e.g., if the identity of the SIM does not match one of the predefined SIM identities. Accordingly, operability and/or functionality of the telephone or handset may be restricted to a connection with one SIM of one or more predefined SIM identities. Thus, for example, operation of the handset may be disabled, when the handset is connected to a SIM having an identity different than the predefined SIM identities, e.g., if the handset is a stolen handset, or if the handset is connected to a SIM of another communication system.

According to some demonstrative embodiments of the invention, controller 126 may include, for example, a processor, a Central Processing Unit (CPU), a Digital Signal Processor (DSP), a microprocessor, a plurality of processors, a chip, a microchip, or any other suitable multi-purpose or specific processor or controller. Memory 132 may include, for example, a RAM, a DRAM, a SD-RAM, a Flash memory, e.g., an embedded Flash memory, a micro-drive, a hard-disk, or any other suitable, e.g., non-volatile, memory or storage.

According to some demonstrative embodiments of the invention, secure module 118 may maintain access information 134 to identify one or more allowed tokens to allow interaction with one or more secure units of secure module 118. For example, access information 134 may identify one or more allowed tokens to allow host processor 116 and/or any other module associated with secure module 118, to selectively access one or more addresses of memory 132, and/or perform one or more operations, e.g., read and/or write operations, on one or more address of memory 132, e.g., as described in detail below.

According to some demonstrative embodiments of the invention, access information 134 may include one or more predefined allowed token identities (IDs), e.g., allowed token ID 136. The one or more allowed token IDs may include any suitable values or numbers identifying one or more tokens, respectively. For example, the one or more allowed token IDs may include two or more SIM identity values identifying two or more respective allowed SIMs to be connected to host 104. The SIM identity value may include, for example, a predefined sequence of digits and/or symbols, e.g., as known in the art. Access information 134 may also include any additional suitable information to identify the one or more allowed tokens. For example, access information 134 may include a key or credential to authenticate a token, e.g., using a challenge-response authentication process.

According to some demonstrative embodiments of the invention, access information 134 may include address information 142, which may include any suitable information identifying one or more selectively-allowed addresses 144. Selectively-allowed addresses 144 may include, for example, one or more addresses to which access of processor 116 may be restricted by controller 126, e.g., as described below. Addresses 144 may also include, for example, one or more addresses which processor 116 may be allowed to access without restriction, or with partial restriction, e.g., to perform only a read operation, as described below. Address information 142 may include any suitable information, e.g., one or more values, identifying one or more ranges of addresses 144, one or more memory locations of addresses 144, and the like.

According to some demonstrative embodiments of the invention, access information 134 may include information identifying one or more access levels relating to one or more of the allowed tokens. Access information 134 may include, for example, at least first and second allowed token IDs. Address information 142 may include, for example, a first set of one or more addresses which may be accessed at one or more access levels, if the identity of token 102 matches the first allowed token ID; and a second set of one or more addresses which may be accessed at one or more access levels, if the identity of token 102 matches the second allowed token ID. For example, the first set of addresses may include one or more addresses to which the first allowed token ID may allow a first access level, e.g., to perform both read and write operations; one or more addresses to which the first allowed token ID may allow a second access level, e.g., to perform only read operation; and/or one or more addresses to which the first allowed token ID may not allow access. The second set of addresses may include, for example, one or more addresses to which the second allowed token ID may allow the first access level; one or more addresses to which the second allowed token ID may allow a second access level; and/or one or more addresses to which the second allowed token ID may not allow access. Although the invention is not limited in this respect, access information 134 may be maintained, in part or in whole, in the form of a table or a list. For example, access information 134 may be maintained in the form of a table including a plurality of allowed token IDs associated with a plurality of address sets, respectively.

According to some demonstrative embodiments of the invention, secure module 118 may include a validity indicator 140. Indicator 140 may have, for example, an allow state and a block state. Although the invention is not limited in this respect, indicator 140 may include, for example a flag value. The flag value may have, for example, a first value, e.g., zero, to indicate the block state; and a second value, e.g., one, to indicate the allow state. Indicator 140 may be implemented in any other suitable form. Indicator 140 may be stored within memory 132, e.g., at a predefined address; implemented separately from memory 132; maintained within controller 126; and/or implemented within module 118 in any other suitable manner.

Although the invention is not limited in this respect, according to some demonstrative embodiments of the invention, access information 134, address information 142 and/or indicator 140 may be maintained in one or more of addresses 144. In other embodiments access information 134, address information 142 and/or indicator 140 may be securely maintained in one or more other addresses 146 of memory 132, e.g., using any suitable protection and/or encryption configuration, arrangement and/or method.

According to some demonstrative embodiments of the invention, controller 126 may authenticate the identity of token 102. For example, controller 126 may communicate with token 102 via processor 116 and port 112, to perform one or more authentication operations, e.g., using any suitable token communication and/or authentication procedure or algorithm, as are known in the art.

According to some demonstrative embodiments of the invention, controller 126 may selectively set the state of indicator 140, based the identity of token 102, e.g., as described below. Controller 126 may set the state of indicator 140, for example, based on the authenticated identity of token 102, and access information 134. For example, controller 126 may set the state of indicator 140 based on a comparison between the identity of token 102 and allowed token ID 136, e.g., as described below.

According to some demonstrative embodiments of the invention, controller 126 may selectively allow processor 116 access to one or more addresses of memory 132, based on the state of indicator 140, e.g., as described below. In one example, controller 132 may allow processor 116 access to one or more of addresses 144, e.g., to perform a read and/or a write operation, only when indicator 140 is at the allow state, e.g., as described below. In a second example, controller 132 may selectively allow processor 116 to access, without restriction or with partial restriction, one or more other addresses 146 when indicator 140 is at the block state. Although the invention is not limited in this respect, in one example, controller 132 may allow processor 116 to perform only a read operation on addresses 146 when indicator 140 is at the block state. In another example, controller 126 may provide processor 116 with unrestricted access to addresses 146, e.g., to perform read and/or write operations, when indicator 140 is at the block state

Some demonstrative embodiments of the invention relate to a secure module, e.g., module 118, including a controller, e.g., controller 126, to selectively allow a host processor, e.g., host processor 116, access to a secure memory, e.g., memory 132. However, the invention is not limited in this respect, and in other embodiments the controller may selectively allow any other processor or unit external to the secure module access to the secure memory.

Some demonstrative embodiments of the invention are described above with reference to a secure module, e.g., module 118, including a controller, e.g., controller 126, to selectively allow a secure unit, e.g., memory 132, to interact with another unit, e.g., host processor 116, external to the secure module, based on an indicator, e.g., indicator 140. However, the invention is not limited in this respect and other embodiments of the invention may include a controller to selectively allow a secure unit to interact with another unit based on any suitable information or criterion, e.g., different than the indicator. For example, controller 126 may selectively allow memory 132 to interact with host processor 116 based directly on access information 134, e.g., based on the first and second sets of addresses described above. In one example, indicator 140 may indicate one or more addresses to which access is to be allowed at one or more access levels, e.g., according to the identity of token 102.

According to some demonstrative embodiments of the invention, system 100 may also include at least one updater 106 able to communicate with host 104 over a communication channel 114. Communication channel 114 may include any suitable communication channel, e.g., a wired or wireless communication channel. Updater 106 may include, for example, a processor 108 and a memory 110. Updater 106 may provide host 104 with an update request to perform one or more operations, e.g., update operations, on access information 134.

According to some demonstrative embodiments of the invention, controller 126 may authenticate the update request and/or an identity of updater 106, e.g., using any suitable authentication method or procedure, as are known in the art. Although the invention is not limited in this respect, memory 132 may include update authentication information 186 to authenticate the update request and/or updater 106. Controller 126 may also establish a secure session with updater 106, e.g., using any suitable session algorithm and/or method, as are known in the art. Controller 126 may allow updater 106 to securely perform, e.g., over the secure session, one or more operations on access information 134. For example, based on the update request, controller 126 may update access information 134, e.g., by deleting one or more token IDs, keys and/or credentials, and/or adding one or more new token IDs, keys and/or credentials; and/or update address information 142.

Although the invention is not limited in this respect, updater 106 may include a server managed by a network operator, for example, if host 104 includes a cellular handset. The server may generate the update request to update access information 134 to include token IDs and/or any other suitable information of one or more allowed SIMs, which may be allowed to be connected to the cellular handset.

Although the invention is not limited in this respect, according to some demonstrative embodiments of the invention, controller 126 may include a verification module 128 and/or a management module 130. Although the invention is not limited in this respect, memory 132 may maintain, e.g., in addresses 146, verification instructions 162, which when executed by controller 126 may result in verification module 128. Memory 132 may also maintain, e.g., in addresses 144, management instructions 164, which when executed by controller 126 may result in management module 128. Verification module 128 and/or management module 130 may be implemented by controller 126 using any other suitable hardware and/or software implementation.

According to some demonstrative embodiments of the invention, verification module 128 may authenticate the identity of token 102; and selectively set the state of indicator 140, e.g., based on the identity of token 102 and/or access information 134, as described herein. Management module 130 may authenticate the update request and/or updater 106; and/or may update access information 134, and/or address information 142, as described herein.

According to some demonstrative embodiments of the invention, controller 126 may perform a Boot procedure, e.g., by executing a sequence of Boot instructions 160. The Boot procedure may include any suitable Boot procedure to be performed upon Booting of secure module 118. Boot instructions 160 may be maintained, for example, in addresses 146. Although the invention is not limited in this respect, controller 126 may set indicator 140 to the block state, e.g., when performing the Boot procedure, as described below. In one example, indicator 140 may be set to the block state, e.g., by clearing indicator 140. In another demonstrative embodiment, controller 126 may set indicator 140 to indicate one or more addresses to which access is to be allowed at one or more access levels, e.g., according to the identity of token 102, as described above.

Some demonstrative embodiments of the invention are described above with reference to a secure module, e.g., module 118, including a controller, e.g., controller 126, to selectively allow a memory, e.g., memory 132, to interact with another unit, e.g., host processor 116, external to the secure module. However, the invention is not limited in this respect and according to some embodiments of the invention the controller may selectively allow another secure unit, e.g., in addition to or instead of the secure memory, to interact with another unit, e.g., as described below.

According to some demonstrative embodiments of the invention, secure module 118 may optionally include secure unit 199. Secure unit 199 may include any suitable, device, unit, module or element to controllably interact with one or more units or elements external to secure module 118. For example, secure unit 199 may include an input controller to control the operation of input 120; an output controller to control the operation of output 122; an antenna controller to control the operation of antenna 125; a connector to connect one or more of processor 116, token, 102, input 120, output 122, and/or network connection 124 to a power source of host 104 (not shown); and/or any other suitable unit. Controller 126 may selectively allow secure unit 199 to interact with one or more units or elements external to secure module 118, for example, based on the identity of token 102, e.g., in analogy to controlling the interaction of memory 132 with host processor 116, as described above. For example, controller 118 may selectively control secure unit 199 to selectively operate input 120, output 122, and/or antenna 125, and/or to provide power to input 120, output 122, antenna 125, host processor 116, and/or token 102, e.g., based on the identity of token 102.

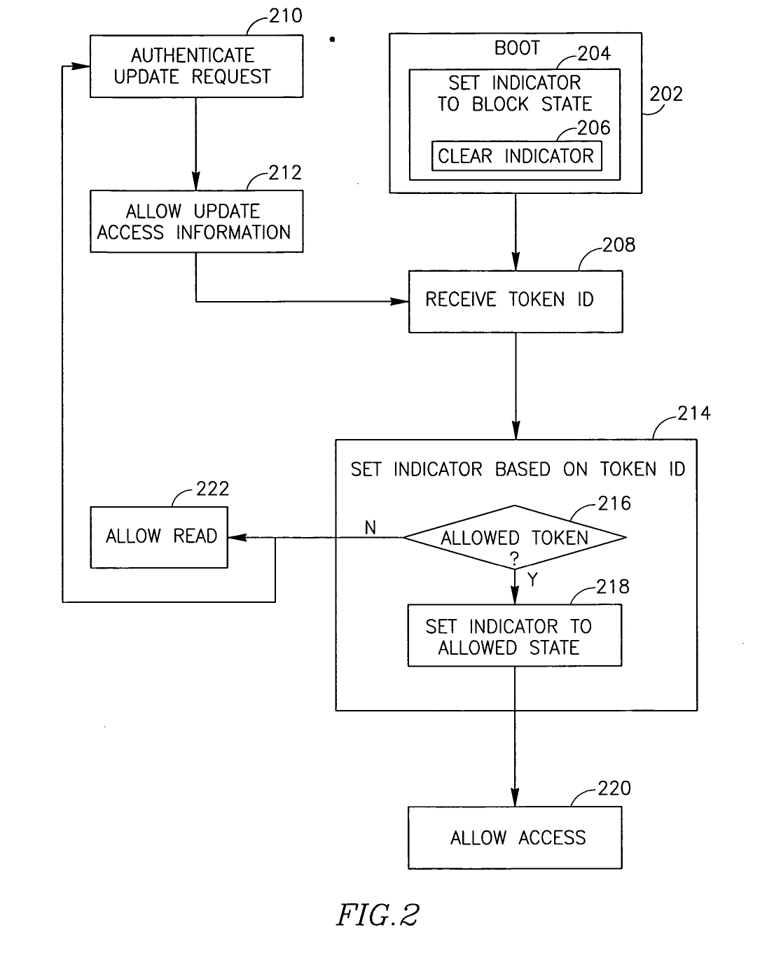

Reference is now made to FIG. 2, which schematically illustrates a method of selectively operating a host connected to a token according to some demonstrative embodiments of the invention. Although the invention is not limited in this respect, one or more operations of the method of FIG. 2 may be performed by host 104 (FIG. 1), controller 126 (FIG. 1), memory 132 (FIG. 1), host processor 116 (FIG. 1), token 102 (FIG. 1), and/or updater 106 (FIG. 1), to selectively allow access to a secure unit of module 118 (FIG. 1), e.g., memory 132 (FIG. 1), based, for example, on access information 134 (FIG. 1).

As indicated at block 202, the method may include performing a Boot procedure. For example, processor 116 (FIG. 1) may perform a host Boot procedure, e.g., as is known in the art; and/or controller 126 (FIG. 1) may perform a Boot procedure, e.g., by executing instructions 160 (FIG. 1).

As indicated at block 204, the method may also include setting a validity indicator to a block state, e.g., upon performing the Boot procedure. Setting the validity indicator to the block state may include, for example, clearing the validity indicator, as indicated at block 206. For example, controller 126 (FIG. 1) may clear indicator 140 (FIG. 1) or set indicator 140 (FIG. 1) to the value zero upon performing the Boot procedure. The validity indicator may be set to the block state in any other way. Accordingly, controller 126 (FIG. 1) may block processor 116 (FIG. 1) from accessing addresses 144 (FIG. 1); and/or prevent secure module 199 (FIG. 1) from interacting with one or more units or elements external to secure module 118 (FIG. 1), e.g., as long as indicator 140 (FIG. 1) is at the block state.

As indicated at block 208, the method may also include authenticating the identity of the token. For example, verification module 128 (FIG. 1) may authenticate the identity of token 102 (FIG. 1). Verification module 128 may perform, for example, a challenge response authentication process to communicate with token 102 (FIG. 1) via processor 116 (FIG. 1) and port 112 (FIG. 1); and to authenticate the identity of token 102 (FIG. 1).

As indicated at block 214, the method may also include selectively setting the state of the validity indicator based on the identity of the token, and access information. As indicated at block 216, selectively setting the validity indicator may include, for example, determining whether the host is allowed to operate with the token. Verification module 128 (FIG. 1) may determine, for example, whether host 104 (FIG. 1) is allowed to operate with token 102 (FIG. 1), e.g., based on access information 134 (FIG. 1). For example, verification module 128 (FIG. 1) may compare the authenticated ID of token 102 (FIG. 1) with the one or more allowed token IDs, e.g., ID 136 (FIG. 1). Host 104 (FIG. 1) may be allowed to operate with token 102 (FIG. 1) if, for example, the authenticated ID of token 102 (FIG. 1) matches one of the allowed token IDs. For example, verification module 128 (FIG. 1) may determine host 104 (FIG. 1) is allowed to operate with token 102 (FIG. 1), if the authenticated ID of token 102 (FIG. 1) matches token ID 136 (FIG. 1).

As indicated at block 218, the method may also include setting the validity indicator to the allow state, e.g., if the host is allowed to operate with the token. For example, verification module 128 (FIG. 1) may set indicator 140 (FIG. 1) to the allow state, e.g., if the authenticated ID of token 102 (FIG. 1) matches token ID 136 (FIG. 1). In another example, controller 126 (FIG. 1) may set indicator 140 (FIG. 1) to indicate one or more addresses to which access is to be allowed at one or more access levels, e.g., according to the identity of token 102 (FIG. 1), as described above.

As indicated at block 220, the method may include selectively allowing, e.g., the host processor, access to one or more memory addresses, e.g., based on the validity indicator. For example, controller 126 (FIG. 1) may allow processor 116 (FIG. 1) and/or any other module external to secure module 118 (FIG. 1) access to one or more of addresses 144 (FIG. 1), e.g., if indicator 140 (FIG. 1) is at the allow state. Access to one or more of the selectively allowed addresses may be blocked, e.g., if the validity indicator is at the block state. For example, controller 126 (FIG. 1) may block processor 116 (FIG. 1) and/or any other module external to secure module 118 (FIG. 1) from accessing one or more of addresses 144 (FIG. 1), e.g., if indicator 140 (FIG. 1) is at the block state. It will be appreciated, that since indicator 140 (FIG. 1) has been set to the block state during the Boot procedure, controller 126 (FIG. 1) may block access to addresses 144, for example, if the identity of token 102 (FIG. 1) does not match one or more of the allowed token IDs.

Although the invention is not limited in this respect, data and/or instructions, which may be required by the host for performing one or more functionality and/or operations, e.g., data and/or instructions to enable functionality of the host, may be maintained in the selectively allowed addresses. Accordingly, the functionality of the host may be selectively disabled based on the identity of the token connected to the host. For example, the functionality of the host may be disabled, partially or entirely, if the identity of the token does not match any of the one or more allowed token IDs. The functionality of the host may be enabled, e.g., only if the identity of the token matches one allowed token IDs. Thus, by defining the allowed token IDs, the host may be allowed to perform one or more functions, e.g., to function properly or desirably, only when connected to one of the allowed token IDs.

As indicated at block 222, the method may also include selectively allowing the processor host to perform one or more predefined operations on one or more of the memory addresses, e.g., if the host is not allowed to operate with the token. In one example, the method may include allowing the host processor to perform a read operation on one or more of addresses 146 (FIG. 1), e.g., and blocking the host processor from performing a write operation on addresses 146 (FIG. 1). In another example, the method may include allowing the host processor to perform both read and write operations on addresses 146 (FIG. 1).

As indicated at block 210, the method may also include authenticating an update request to update the access information and/or the address information. In one example, management module 130 (FIG. 1) may communicate with updater 106 (FIG. 1) over channel 114 (FIG. 1), and perform an authentication procedure to authenticate updater 106 (FIG. 1). The communication with the updater may be established, for example, upon determining that the host is not allowed to operate with the token, e.g., in order to allow the updater to update the access information such that it includes the identity of the token, if desired. In another example, management module 130 (FIG. 1) may authenticate a received update request.

As indicated at block 212, the method may also include allowing the update request to update the access information and/or the address information. For example, controller 126 (FIG. 1) may allow updater 106 to update access information 134 (FIG. 1) and/or address information 142 (FIG. 1), if desired.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A host apparatus connectable to a token, said host comprising:
a host processor to communicate with said token; and
a secure module comprising:
a secure unit; and
a controller to authenticate an identity of said token and, based on said identity, to selectively allow said secure unit to interact with another unit of said host.

2. The apparatus of claim 1, wherein said secure unit comprises a memory, and wherein said controller selectively allows access to one or more memory addresses of said memory based on said identity.

3. The host apparatus of claim 2, wherein said secure module maintains access information indicating at least one allowed token to allow access to one or more selectively-allowed addresses of said memory, and wherein said controller selectively allows access to said selectively-allowed addresses based on said access information.

4. The host apparatus of claim 3, wherein said secure module comprises an indicator having an allow state and a block state, and wherein said controller allows access to said selectively-allowed addresses only when said indicator is at said allow state.

5. The host apparatus of claim 4, wherein said controller selectively sets said indicator to said allow state based the identity of said token.

6. The host apparatus of claim 4, wherein said indicator is set to said block state when said secure module is booted.

7. The host apparatus of claim 4, wherein said controller allows access to one or more other memory addresses of said memory when said indicator is at said block state.

8. The host apparatus of claim 7, wherein said controller allows performing only a read operation on said other memory addresses when said validity indicator is at said block state.

9. The host apparatus of claim 3, wherein said at least one allowed token comprises at least one group of two or more allowed tokens, and wherein said controller allows access to said selectively-allowed addresses if the identity of said token matches one of said two or more allowed tokens.

10. The host apparatus of claim 3, wherein said controller authenticates an update request to update said access information.

11. The host apparatus of claim 2, wherein said memory comprises a non-volatile memory.

12. The host apparatus of claim 11, wherein said non-volatile memory module comprises an embedded flash memory.

13. The host apparatus of claim 1, wherein said controller performs a challenge-response authentication process to authenticate the identity of said token.

14. The host apparatus of claim 1 comprising a wireless communication device.

15. The host apparatus of claim 1 comprising a cellular handset.

16. The host apparatus of claim 1, wherein said token comprises a token selected from the group consisting of a subscriber-identity-module, a universal subscriber identity module, and a removable user identity module.

17. A method of selectively operating a host connected to a token, said method comprising:
authenticating an identity of said token; and
based on said identity, selectively allowing a secure unit of said host to interact with another unit of said host

18. The method of claim 17, wherein said selectively allowing comprises selectively allowing access to one or more memory addresses of a secure memory of said host.

19. The method of claim 18 comprising securely maintaining access information indicating at least one allowed token to access one or more selectively-allowed addresses of said secure memory, wherein said selectively allowing comprises selectively allowing access to said selectively-allowed addresses based on said access information.

20. The method of claim 18 comprising selectively setting a state of an indicator to an allow state based on said identity, and wherein said selectively allowing comprises allowing access to said selectively-allowed addresses only when said indicator is at said allow state.

21. The method of claim 20 comprising setting said indicator to a block state when performing a boot operation.

22. The method of claim 20 comprising allowing access to one or more other memory addresses of said memory when said indicator is at a block state.

23. The method of claim 22 comprising allowing performing only a read operation on said other memory addresses when said validity indicator is at a block state.

24. The method of claim 19, wherein maintaining said access information comprises maintaining access information indicating at least one group of two or more allowed tokens, and wherein said selectively allowing comprises allowing access to said selectively-allowed addresses if the identity of said token matches one of said two or more allowed tokens.

25. The method of claim 17 comprising authenticating a predefined update request to update said access information.

26. The method of claim 17, wherein authenticating the identity of said token comprises authenticating the identity of a subscriber-identity-module.
